(19) United States
(12) Patent Application Publication
(10) Pub. No.: US 2004/0254017 A1
(43) Pub. Date: Dec. 16, 2004

(54) [SOUND DEVICE OF VIDEO GAME SYSTEM]

(75) Inventors: Ming-Kuo Cheng, TAIPEI (TW); Chiu-Hao Cheng, TAIPEI (TW); Chi-Fu Peng, TAIPEI (TW)

Correspondence Address: ZEROPLUS TECHNOLOGY CO., LTD., 2F-4, NO. 184, SEC. 4, CHUNG HSIAO EAST ROAD, TAIPEI, TW

(73) Assignees: VISION ELECTRONICS CO., LTD., CHUNGLI CITY, TAOYUAN HSIEN (TW); ZEROPLUS TECHNOLOGY CO., LTD, CHUNGHO CITY, TAIPEI HSIEN (TW)

(21) Appl. No.: 10/709,642

(22) Filed: May 19, 2004

(30) Foreign Application Priority Data
Jun. 11, 2003 (TW) 092210674

(51) Int. Cl. A63F 13/00

(52) U.S. Cl. 463/35

(57) ABSTRACT

A video game system having sound device is provided. The video game system comprises a sound adaptor and a sound device connected to a first memory card slot and a second memory card slot of a game controller of the video game player such that a user can communicate with other users through a built-in microphone and speaker of the sound device within a valid range via wireless controller. Therefore, a user can directly execute a game by wirelessly controlling the game controller without wearing wired earphone and microphone.

### CROSS REFERENCE TO RELATED APPLICATIONS

This application claims the priority benefit of Taiwan patent application number 092210674 filed on Jun. 11, 2003.

### BACKGROUND OF INVENTION

1. The Field of the Invention

The present invention relates to a video game system, and more particularly to a video game system having sound device comprising a sound adaptor and a sound device connected to a first memory card slot and a second memory card slot of a game controller of a video game player such that a player can wirelessly communicate with other players via a microphone and a speaker of the sound device within a valid range via the game controller. Therefore, a player can directly execute a game by wirelessly controlling the game controller without wearing wired earphone and microphone.

2. Description of Related Art

Presently, the online games are popular. Nowadays players can play not only PC games but also the online internet games. Several manufacturers have invested in developing various peripheral products for the video games with a view of achieving user-friendly operations and to provide more convenience to the players. For example, some manufacturers designed using earphone and speaker to enable the player to communicate with other players while playing the game in order to create more fun.

Referring to FIGS. 1A, 1B, 1C and 2, elevational views of a conventional video game system, and elevational view of a conventional game controller and a sound adaptor, a headset and a block diagram of a circuit of a sound device, are respectively shown. The peripheral products available for video game player, Xbox of Microsoft, includes a video game player 10, a game controller 20, a sound adaptor 30, a sound device 40 comprising an earphone 41 and a microphone 42. The game controller 20 comprises a first memory card slot 22 which is adapted for receiving the sound adaptor 30 having external card bus for allowing communication between the second communication interface 35 and the game controller 20. The earphone and the microphone 42 are connected to the sound adaptor 30 via the sound transmission wire 43 and the headset jack 34. Thus, the first control circuit 21 and the first communication interface 25 of the game controller 20 can communicate with the video game player 10. Furthermore, the game controller 20 comprises a second memory card slot 23 and buttons 24. The second memory card slot 23 is a reserved slot and the buttons 24 are adapted for controlling the functions of the game. Furthermore, the sound adaptor 30 comprises a second control circuit 31, a volume regulator 32 and a microphone switch 33. The second control circuit 31 is adapted for controlling the volume of the earphone 41 and also for turning on/off the microphone 42.

However, the above conventional video game system has the following defects.

1. The specifications of the earphone 41 and the microphone 42 are different from the other available products, therefore, if the earphone 41 and the microphone 42 are damaged, the user must purchase the whole set as a replacement. Thus, the cost is high and thereby discouraging some players from buying such video game system.

2. The earphone 41 and the microphone 42 must be connected via the sound transmission wire 43 to communicate with the sound adaptor 30 for controlling the game controller 20, and because the length of the wire is limited and may get entangled, therefore causing inconvenience to players.

3. Because the earphone 41 and the microphone 42 are designed to directly contact the player's ear, and also the weight of the earphone 41 and the microphone 42 can cause uneasiness to the player after a long time usage.

4. The player cannot move freely due to the wired connection of the sound transmission wire 43 and the controller transmission wire.

5. The volume regulator 32 and the microphone switch 33 cannot be controlled instantly.

Besides, the other available video game player, PS2 of Sony, particularly for playing online game, has built-in control interface of the earphone and the microphone. The disadvantage of this product is that the players cannot move freely due to the sound transmission wire and the controller transmission wire.

### SUMMARY OF INVENTION

Accordingly, in the view of the foregoing, the present inventor makes a detailed study of related art to evaluate and consider, and uses years of accumulated experience in this field, and through several experiments, to create a new sound device of video game system. The present invention provides an innovated cost effective sound device of video game system such that a user can execute a game by wirelessly controlling the game controller and wirelessly communicate with other users via the game controller within a valid range without wearing wired microphone and speaker.

According to an aspect of the present invention, the sound device of the video game comprises a control circuit, a speaker, a microphone, a sound transmission wire and a communication interface. The sound device is connected to a first memory card slot of the game controller via the sound transmission wire so that a player can play the game without wearing the earphone and microphone. The player can communicate with other players via the speaker and the microphone of the sound device inserted into the second memory card slot, thus the players can have more fun.

According to another aspect of the present invention, the game controller comprises a second memory card slot for power connection to provide power for operating video game player. The headset jack at the distal end of the sound transmission wire is connected to the sound adaptor positioned in the first memory card slot, thus sound signals and data signals can be transmitted/received via sound adaptor and sound device to facilitate the game execution without requiring to wear the earphone and microphone.

According to another aspect of the present invention, the speaker and the microphone are installed in the game controller. When the player adjusts the volume switch of the microphone, the signal generated while adjusting the volume regulator and the microphone switch is sent to the first control circuit via the second control circuit, the headset jack and the sound transmission wire. The first control circuit is adapted for controlling the volume of the speaker and also for turning on/off the microphone. Therefore, the on-line players need not wear the earphone or microphone while playing the game.

### BRIEF DESCRIPTION OF DRAWINGS

For a more complete understanding of the present invention, reference will now be made to the following detailed description of preferred embodiments taken in conjunction with the following accompanying drawings.

FIG. 1A is an elevational view of a conventional video game system.

FIG. 1B is an elevational view of a conventional game controller and sound adaptor.

FIG. 1C is an elevational view of a conventional headset.

FIG. 2 is a block diagram of a circuit of a conventional video game system.

FIG. 3A is the elevational view (1) of a video game system according to an embodiment of the present invention.

FIG. 3B is an elevational view (2) of a video game system according to an embodiment of the present invention.

FIG. 3C is a elevational view (3) of a video game system according to an embodiment of the present invention.

FIG. 3D is an elevational view (4) of a video game system according to an embodiment of the present invention.

FIG. 3E is an elevational view (5) of a video game system according to an embodiment of the present invention.

FIG. 3F is an elevational view (6) of a video game system according to an embodiment of the present invention.

FIG. 4 is a block diagram of a circuit of a video game system according to an embodiment of the present invention.

FIG. 5A is an elevational view (1) of a video game system according to an embodiment of the present invention.

FIG. 5B is an elevational view (2) of a video game system according to an embodiment of the present invention.

FIG. 5C is an elevational view (3) of a video game system according to an embodiment of the present invention.

FIG. 5D is an elevational view (4) of a video game system according to an embodiment of the present invention.

FIG. 5E is an elevational view (5) of a video game system according to an embodiment of the present invention.

FIG. 5F is an elevational view (6) of a video game system according to an embodiment of the present invention.

FIG. 6 is a block diagram of a circuit of a video game system according to an embodiment of the present invention.

FIG. 7 is a block diagram of a circuit of a video game system according to another embodiment of the present invention.

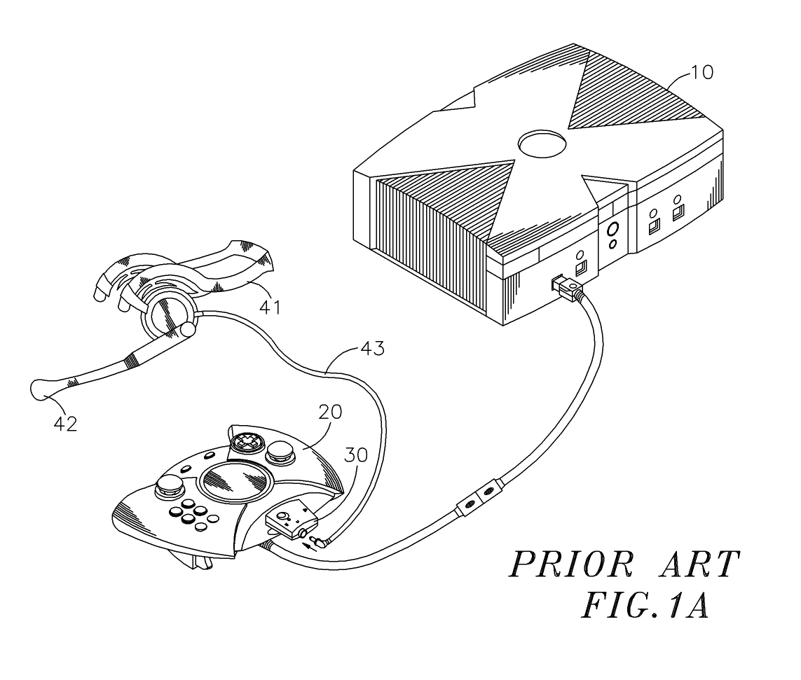

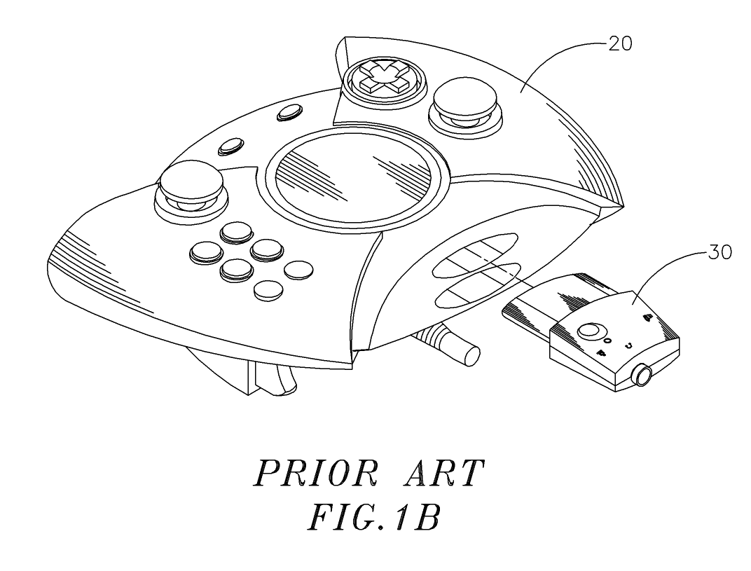

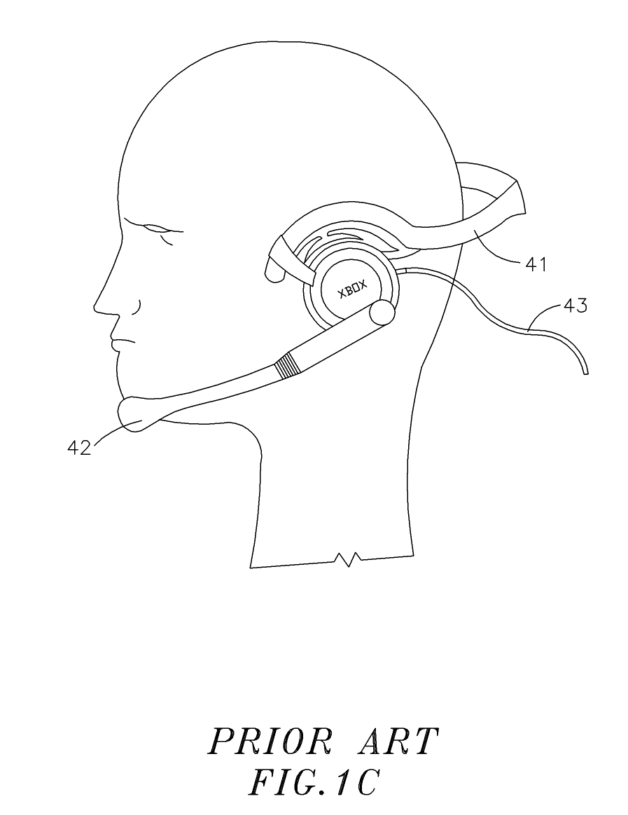

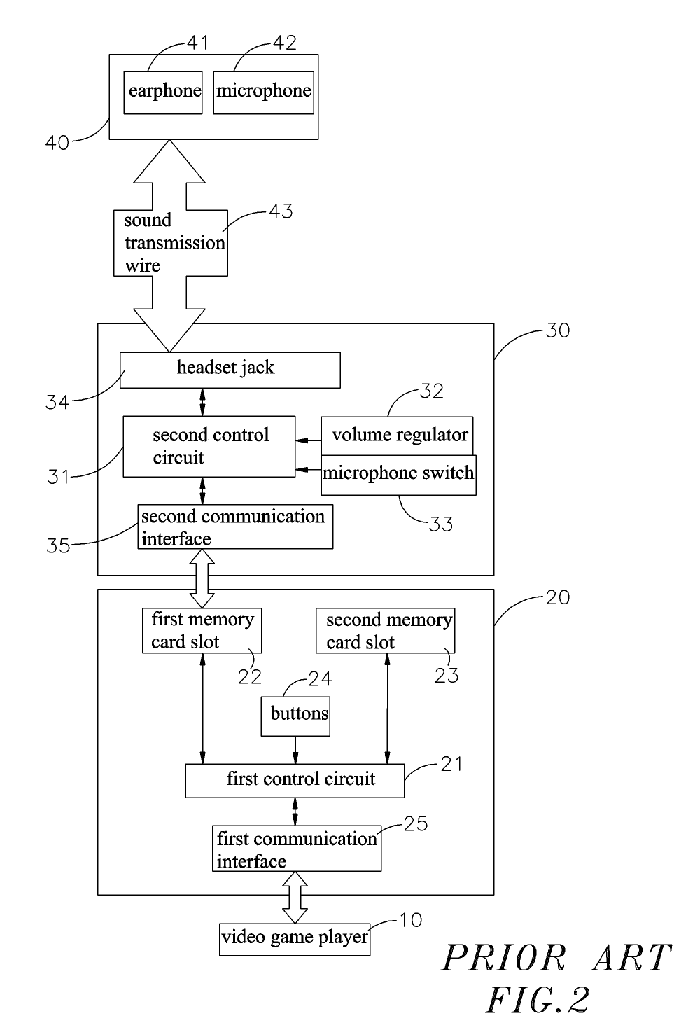

### DETAILED DESCRIPTION

Reference will be made in detail to the preferred embodiments of the invention, examples of which are illustrated in the accompanying drawings. Wherever possible, the same reference numbers are used in the drawings and the description to refer to the same or like parts.

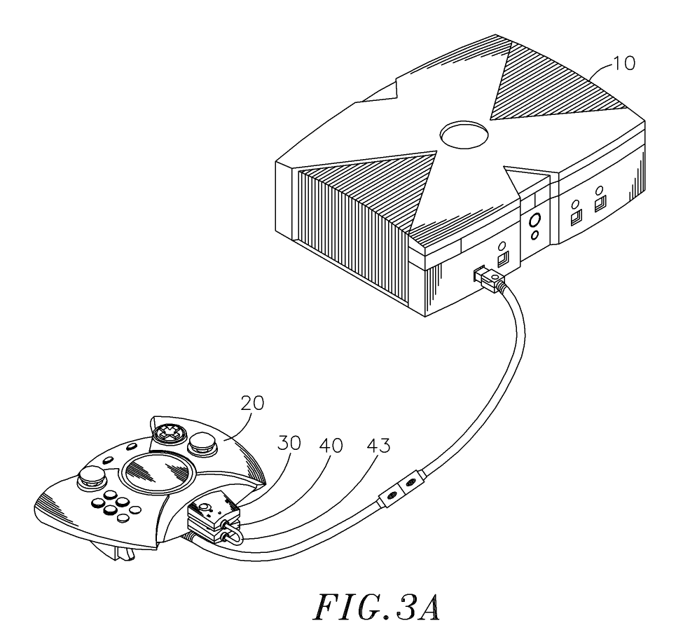

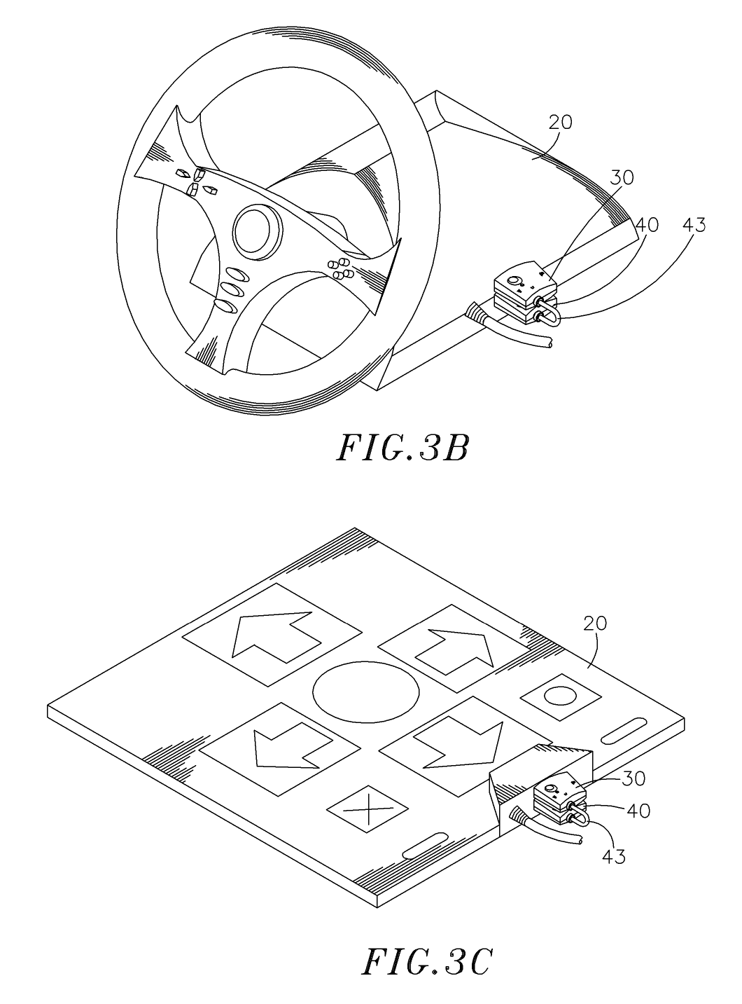

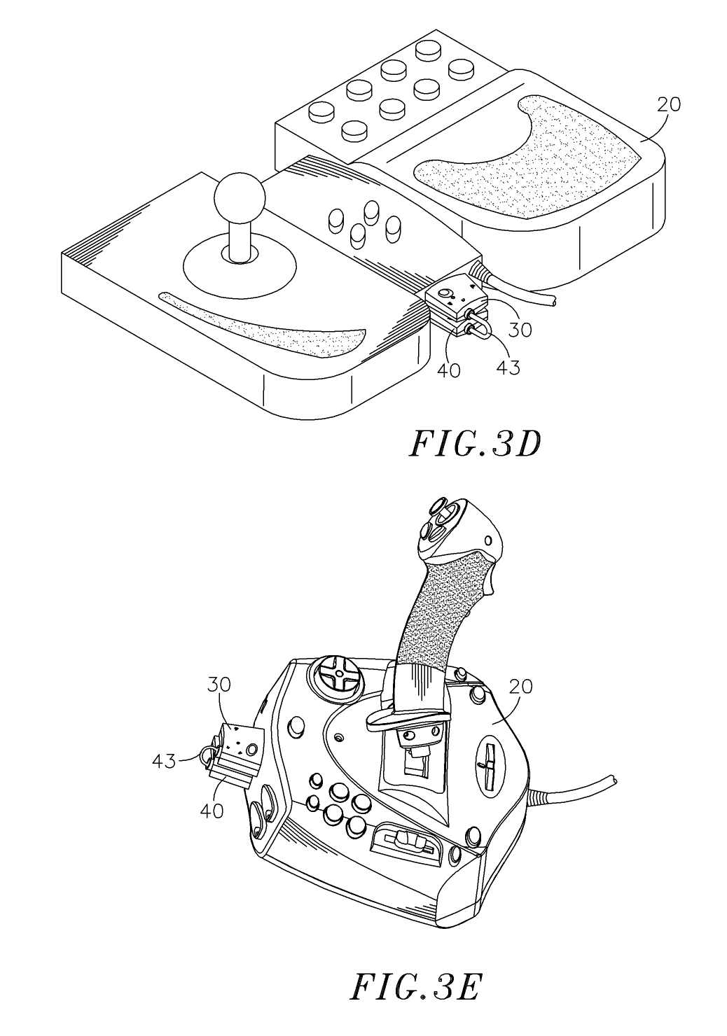

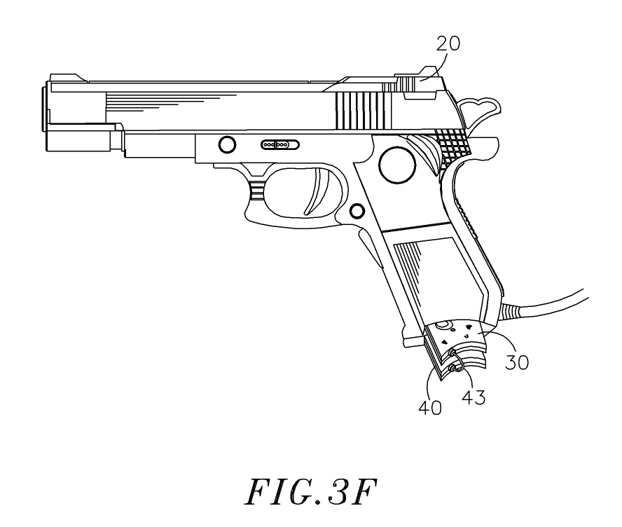

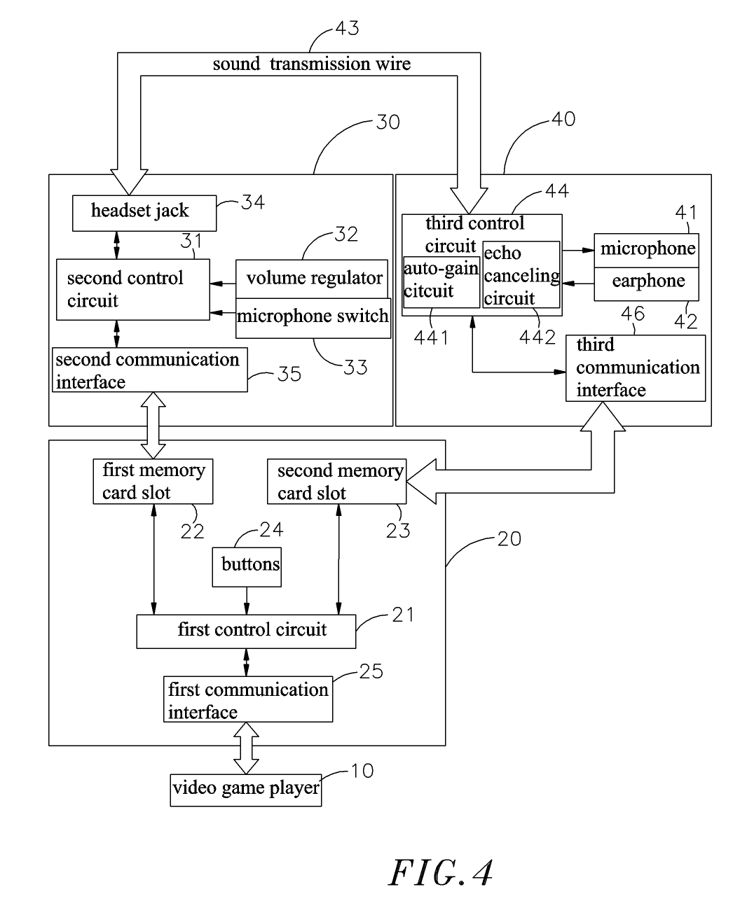

Referring to FIG. 3A and FIG. 4, an elevational view (1) of a video game system and a block diagram of a circuit of a video game system according to an embodiment of the present invention are respectively shown. The video game system comprises a video game player 10, a game controller 20, a sound adaptor 30 and a sound device 40. The video game player 10 is connected to a game controller 20. The game controller 20 is connected to a sound adaptor 30 and the sound device 40.

The game controller 20 comprises a first control circuit 21, a first memory card slot 22, a second memory card slot 23, a button 24 and a first communication interface 25, wherein the first memory card slot 22, the second memory card slot 23, the button 24 and the first communication interface 25 are connected to the first control circuit 21. The sound adaptor 30 is connected to the first memory card slot 22 and the sound device 40 is connected to the second memory card slot 23.

The sound adaptor 30 comprises a second control circuit 31, a volume regulator 32, a microphone switch 33, a headset jack 34 and a second communication interface 35, wherein the volume regulator 32, the microphone switch 33, the headset jack 34 and the second communication interface 35 are connected to the second control circuit 31. The headset jack 34 is connected to a third control circuit 44 of the sound device 40 through a sound transmission wire 43.

Furthermore, the sound device 40 comprises the third control circuit 44, a speaker 45, a microphone 42, a sound transmission wire 43 and a third communication interface 46, wherein the speaker 45, the microphone 42, the sound transmission wire 43 and the third communication interface 46 are connected to the third control circuit 44. The third control circuit 44 receives a sound signal sent from the sound adaptor 30 via the sound transmission wire 43, as well as a sound signal input by a user transmitted by the microphone 42. The speaker 45 receives the sound signal transmitted from the third circuit 44.

Hereinafter, the assembly of the video game system will be described. The game controller 20 is connected to the video game player 10. Next, the sound adaptor 30 is inserted into the first memory card slot 22 of the game controller 20. Next, the headset jack 34 of the sound adaptor 30 is connected into the third control circuit 44 of the sound device 40 via the sound transmission wire 43.

Furthermore, the game controller 20 is adapted to control the buttons 24 to transmit signals in an orderly manner via the first control circuit 21 and the first communication interface 25 to the video game player 10.

The volume regulator 32 and the microphone switch 33 are adapted for adjusting the volume of the speaker 45 of the sound device 40 and also for turning on/off the microphone 42. The signals generated during the volume adjustment are transmitted in orderly manner via the second control circuit 31, the headsetjack 34 and the sound transmission wire 43 to the third control circuit 44.

Furthermore, the third control circuit 44 comprises an auto-gain circuit 441 and an echo canceling circuit 442. The auto-gain circuit 441 is adapted for balancing the over loud volume sound or a low volume sound. The echo canceling circuit 442 is for canceling the echo.

Now referring to FIG. 3A-3F, are elevational views (1), (2), (3), (4), (5) and (6) of a video game systems according to various embodiments of the present invention, wherein the game controller 20 can be a palm joystick, a steering wheel, a dancing pad, a joystick, a flight joystick or a light beam gun.

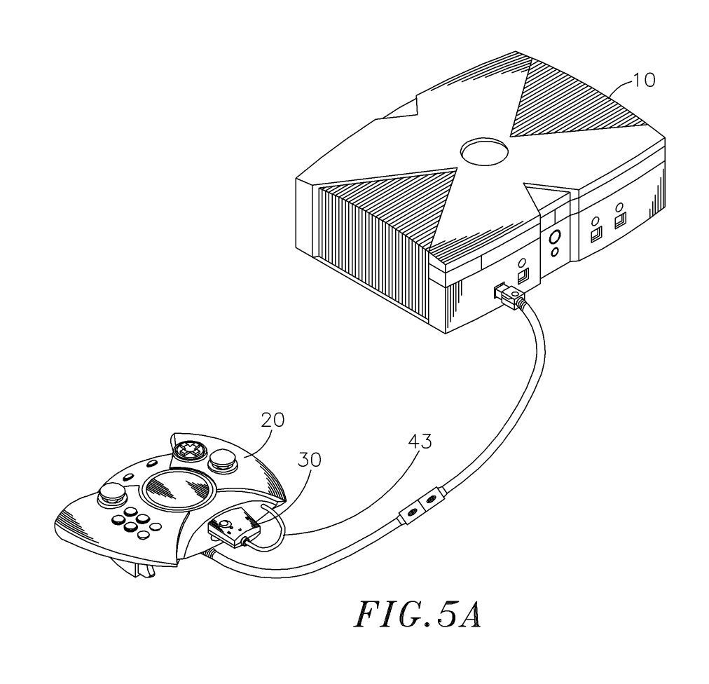

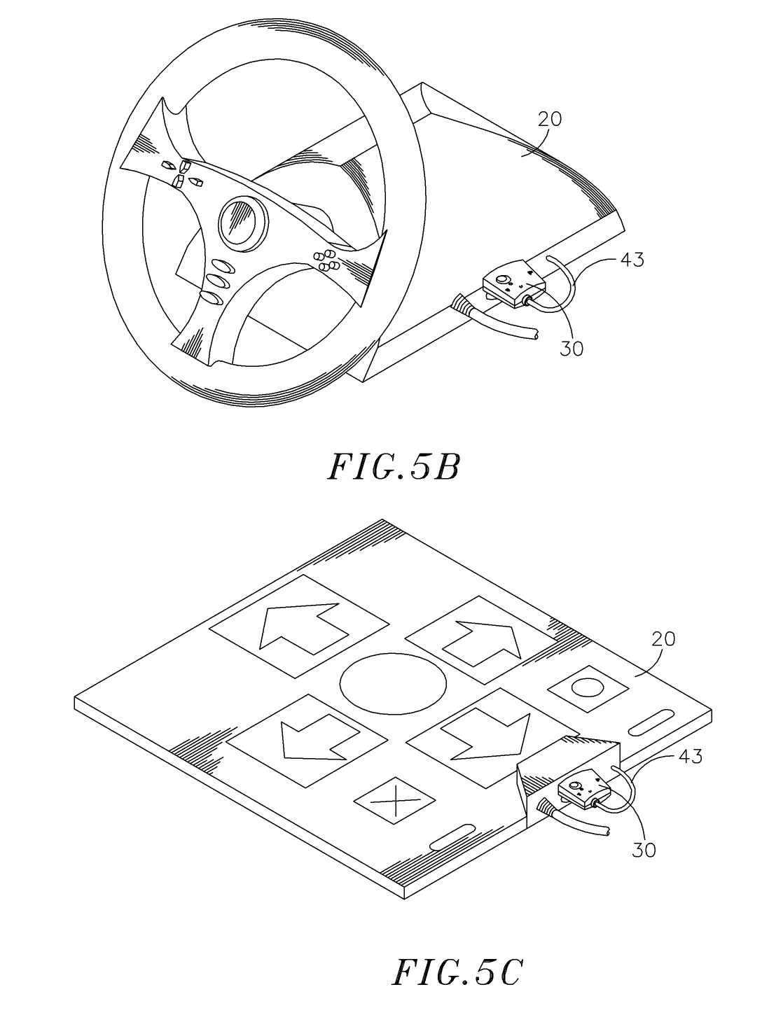

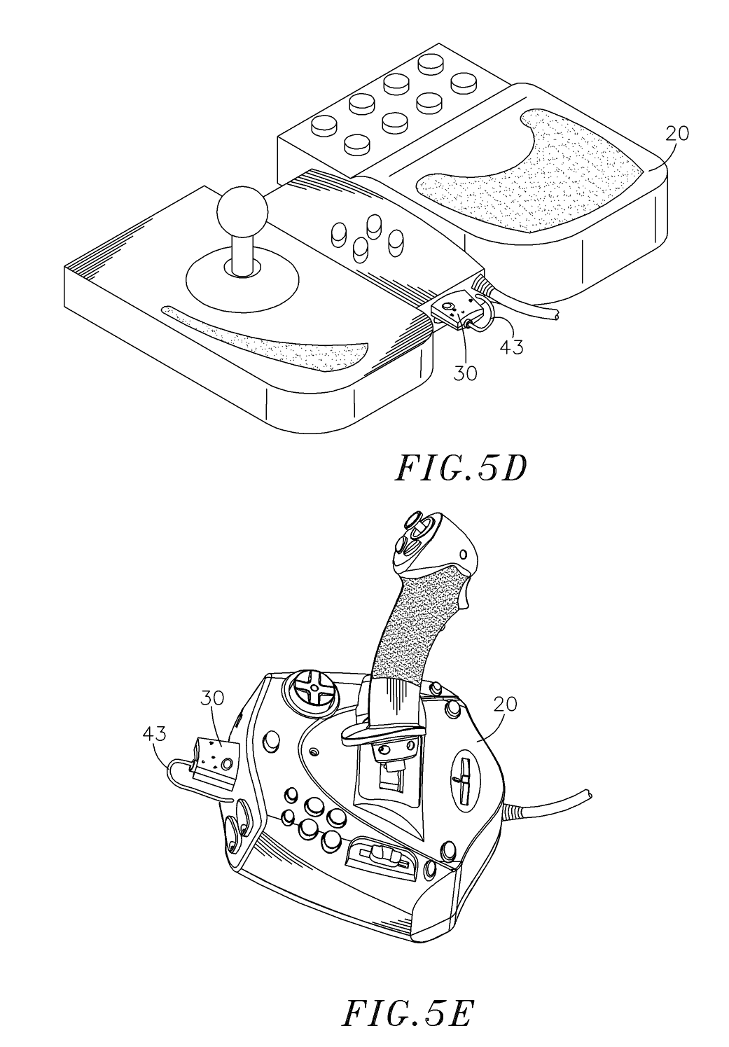

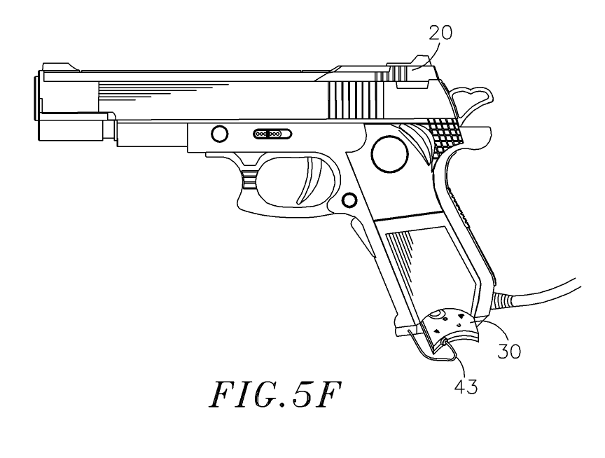

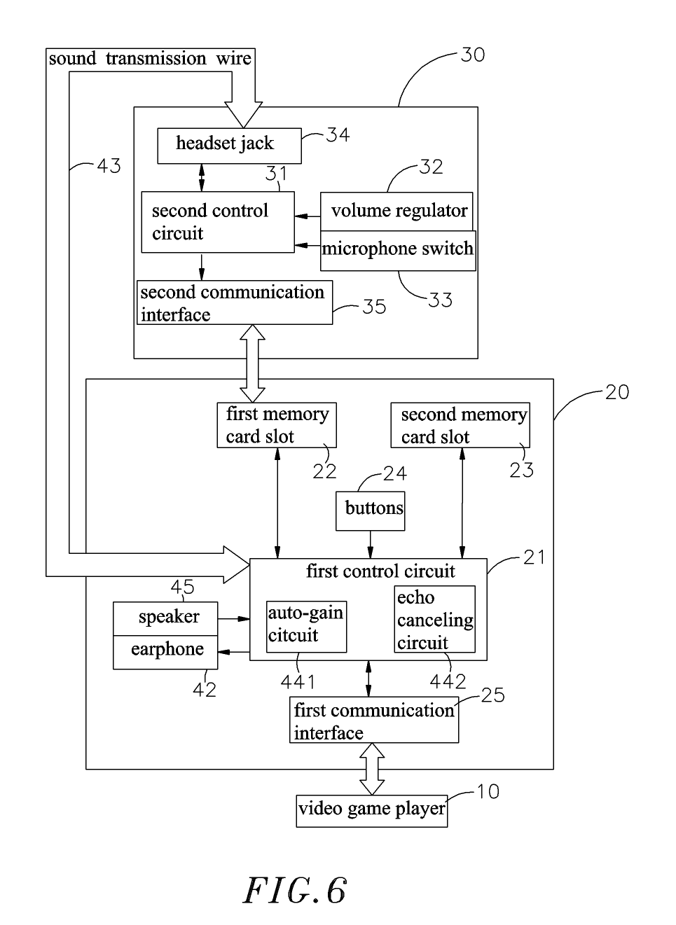

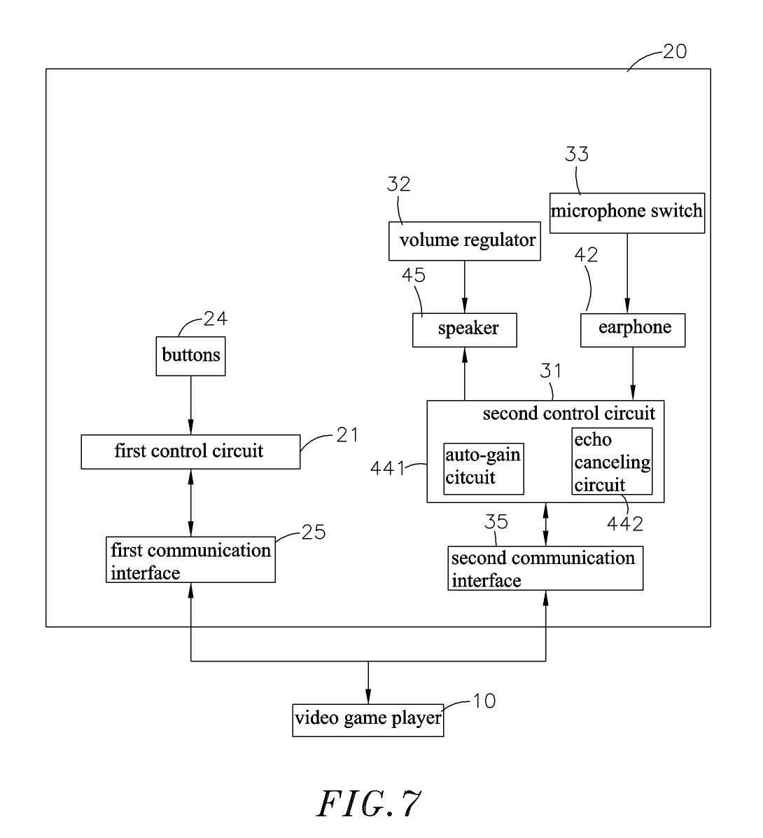

Besides, FIGS. 5A and 6, are elevational view (1) and a block diagram of a circuit of a video game system according an embodiment of the present invention, wherein the speaker 45 and the microphone 42 are installed directly in the game controller 20. Thus when a player adjusts the volume of the speaker 45 and switch on/off the microphone 42 by operating the volume regulator 32 and the microphone switch 33, signals generated during the operation of the volume regulator 32 and the microphone switch 33 will be transmitted via the second control circuit 31, the headset jack 34 and the sound transmission wire 43 to the first control circuit 21.

Referring to FIGS. 5A-5F, elevational views (1), (2), (3), (4), (5) and (6) of a video game system according to various embodiments of the present invention are respectively shown. The game controller 20 can be a palm joystick, a steering wheel, a dancing pad, a joystick, a flight joystick or a light beam gun.

Furthermore, referring to FIG. 7, a block diagram of a circuit of a video game system according to another embodiment of the present invention is shown. The video game player 10 is connected to the game controller 20. The game controller 20 comprises the first communication interface 25 and the second communication interface 35. The first communication interface 25 is connected to the first control circuit 21 and the buttons 24. The second communication interface 35 is connected to the second control circuit 31. The second control circuit 31 is connected to the speaker 45, the volume regulator 32, the microphone 42 and the microphone switch 33. During the operation of the video game system according the present embodiment of the present invention, the game controller 20 controls the buttons 24 to generate a signal, which is transmitted to the video game player 10 via the first control circuit 21 and the first communication interface 25 in orderly manner. The video game player 10 generates a sound signal and transmits the sound signal to the speaker 45 via the second communication interface 35 and the second control circuit 31 in orderly manner. The volume regulator 32 is adapted for adjusting the volume of the sound device. Furthermore, the microphone 45 receives the sound signal input by the user, and then transmits the sound signal to the video game player 10 in orderly manner via the second control circuit 31 and the second communication interface 35. The microphone switch 33 is adapted for turning on or off the microphone 42. Furthermore, the second control circuit 31 comprises the auto-gain circuit 441 and the echo canceling circuit 442. The auto-gain circuit 441 is adapted for balancing the over loud volume sound or a low volume sound. The echo canceling circuit 442 is for canceling the echo.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and nonlimiting sense.

1. A video game system having sound device, comprising:
a video game player, comprising a game controller, said game controller comprising a first memory card slot, a second memory card slot and buttons
a sound adaptor comprising a second control circuit, a microphone switch and a volume regulator, wherein said first memory card slot is adapted for receiving said sound adaptor;
a headset jack, connected to said second control circuit;
a sound device, connected to said game controller of said video game player, wherein said sound device can be received in said second memory card slot, wherein said sound device comprises a third communication interface, a third control circuit and a speaker, a microphone and a sound transmission wire, wherein said third communication interface, said speaker, said microphone and said sound transmission wire are connected to said third control circuit, said third communication interface is connect to said second memory card slot of said game controller; said third control circuit is connected to said headset jack of said sound adaptor via said sound transmission wire for allowing a signal communication between said sound adaptor and said third control circuit of said sound device via said sound transmission wire, and wherein said third control circuit is adapted for controlling a volume of said speaker and for turning on/off said microphone.

2. The video game system having sound device according to claim 1, wherein said third control circuit comprises an auto-gain circuit for balancing an over loud volume sound or a low volume sound and an echo canceling circuit for canceling an echo.

3. The video game system having sound device according to claim 1, wherein said game controller is a palm joystick.

4. The video game system having sound device according to claim 1, wherein said game controller is a steering wheel.

5. The video game system having sound device according to claim 1, wherein said game controller is a dancing pad.

6. The video game system having sound device according to claim 1, wherein said game controller is ajoystick.

7. The video game system having sound device according to claim 1, wherein said game controller is a flight joystick.

8. The video game system having sound device according to claim 1, wherein said game controller is a light beam gun.

9. A video game system having sound device, comprising:
a video game player;
a sound adapter, comprising a second control circuit, a second communication interface, a volume regulator, a microphone switch and a headset jack, wherein said second communication interface, said volume regulator, said microphone switch and said headset jack are connected to said second control circuit;
a game controller comprising a first control circuit, a first memory card slot, buttons, a speaker and a microphone, said first control circuit, said first memory card slot, said buttons, said speaker and said microphone are connected to said first control circuit, said game controller being connected to a second communication interface of said sound adaptor by a first memory card slot, and game controller is connected to said video game player via said first communication interface, and wherein said first control circuit is connected to said headset jack of said sound adaptor via a sound transmission wire allowing a signal communication between said sound adaptor and said first control circuit of said game controller via said sound transmission wire, and wherein said first control circuit is adapted for controlling a volume of said speaker and for turning on/off said microphone.

10. The video game system having a sound device according to claim 9, wherein said first control circuit comprises an auto-gain circuit for balancing an over loud volume sound or a low volume sound and an echo canceling circuit for canceling an echo.

11. The video game system having sound device according to claim 9, wherein said game controller is a palm joystick.

12. The video game system having sound device according to claim 9, wherein said game controller is a steering wheel.

13. The video game system having sound device according to claim 9, wherein said game controller is a dancing pad.

14. The video game system having sound device according to claim 9, wherein said game controller is ajoystick.

15. The video game system having sound device according to claim 9, wherein said game controller is a flight joystick.

16. The video game system having sound device according to claim 9, wherein said game controller is a light beam gun.

17. A sound device of video game system, said video game system comprising at least a video game player and a game controller having a first control circuit, said game controller connected to said video game player, said game controller comprising:
a second control circuit;
a first communication interface, connected to said first control circuit and buttons; and
a second communication interface, connected to said second control circuit, wherein said second control circuit is connected to a speaker, a volume regulator, a microphone and a microphone switch so that second control circuit can transmit a sound signal generated by said video game player via second communication interface to said speaker, wherein said volume regulator is adapted for adjusting a volume of said speaker.

18. The sound device of video game system having a sound device according to claim 17, wherein said first control circuit comprises an auto-gain circuit for balancing an over loud volume sound or a low volume sound, and an echo canceling circuit for canceling echo.

19. The sound device of video game system having a sound device according to claim 17, wherein said game controller is a palm joystick.

20. The sound device of video game system having a sound device according to claim 17, wherein said game controller is a steering wheel.

21. The sound device of video game system having a sound device according to claim 17, wherein said game controller is a dancing pad.

22. The sound device of video game system having a sound device according to claim 17, wherein said game controller is ajoystick.

23. The sound device of video game system having a sound device according to claim 17, wherein said game controller is a flight joystick.

24. The sound device of video game system having a sound device according to claim 17, wherein said game controller is a light beam gun.
